(19) United States
(12) Patent Application Publication
(10) Pub. No.: US 2025/0232384 A1
(43) Pub. Date: Jul. 17, 2025

(54) MAPPING TAX STRUCTURES VIA NATURAL LANGUAGE PROCESSING GENERATED DIRECTED ACYCLIC GRAPHS

(71) Applicant: HRB Innovations, Inc., Wilmington, DE (US)

(72) Inventors: Ian Thompson, Wilmington, DE (US); Jeff Herman, Wilmington, DE (US); Daniel Hajialigol, Wilmington, DE (US); Cody Kesler, Wilmington, DE (US)

(21) Appl. No.: 18/414,771

(22) Filed: Jan. 17, 2024

(51) Int. Cl. G06Q 40/12; G06F 40/40

(52) U.S. Cl. CPC G06Q 40/123; G06F 40/40

(57) ABSTRACT

Systems and methods for generating a tax structure and modeling a tax return using the tax structure. The tax structure may be generated by parsing and translating tax law information using natural language processing techniques. The tax law information may be parsed for tax fields associated with the tax law information as well as dependencies between the tax fields. The tax fields as well as the dependencies between them may then be used to assemble a tax structure. The tax structure may include nodes connected by edges, where the nodes include models. The system may obtain tax return information, input the tax return information into the tax structure, and create a tax return model. The system may obtain information on anomalies in the tax fields. The systems and methods may cause the display of one or more indicators associated with the anomalies in the tax return model.

### FIELD

Embodiments of the invention generally relate to systems and methods for modeling tax preparation and, more particularly, to systems and methods of mapping tax structures using graphs for efficient tax calculations.

### BACKGROUND

The tax preparation process is prone to human error. Small decisions can make a large impact on how much a person owes the Internal Revenue Service (IRS) or is owed by the IRS. Given the large number of fields to fill out, it is not uncommon for tax preparers to make errors that result in an undesirable outcome, such as owing more or receiving less money. Unfortunately, due to the complexity of the tax system, it can be difficult and time-intensive to trace and calculate the effects of errors and the effect they have on the overall tax return.

Furthermore, the tax code often changes yearly, making it difficult to build a comprehensive, reusable system that precisely calculates the effects of singular tax decisions. What is needed are systems and methods for modeling a given tax year to determine the effects of singular tax decisions and errors. As such, systems and methods are desired for quickly and efficiently calculating the effects that tax decisions or errors have on a given tax return.

### SUMMARY

In some aspects, the techniques described herein relate to one or more non-transitory computer-readable media including computer-executable instructions that, when executed by at least one processor, perform a method of generating a tax structure modeling a tax year, the method including: obtaining, from one or more databases, tax information associated with the tax year, the tax information including tax law; parsing, by a word transformer, one or more tax fields from the tax information; determining, by a relationship transformer, one or more dependencies between the one or more tax fields; and generating, using the one or more dependencies and the one or more tax fields, the tax structure including: one or more nodes including one or more models, the one or more models configured to calculate one or more output values; and one or more edges, the one or more edges including one or more weights, the one or more weights corresponding to the one or more output values, wherein the one or more nodes are connected to at least one node from the one or more nodes by at least one edge from the one or more edges.

In some aspects, the techniques described herein relate to one or more non-transitory computer-readable media, wherein the tax structure is a first tax structure, and the tax year is a first tax year; and wherein the method further includes: receiving a second tax structure modeling a second tax year, the second tax year being different than the tax year; and comparing the second tax structure to the tax structure such that a set of differences between the tax year and the second tax year may be determined.

In some aspects, the techniques described herein relate to one or more non-transitory computer-readable media, wherein the method further includes: obtaining tax return information associated with a taxpayer, the tax return information including one or more tax field values; and inputting the one or more tax field values into the tax structure to create a tax return model such that the one or more models calculate the one or more output values.

In some aspects, the techniques described herein relate to one or more non-transitory computer-readable media, wherein the method further includes: detecting, by an anomaly detector, one or more anomalies associated with the one or more output values.

In some aspects, the techniques described herein relate to one or more non-transitory computer-readable media, wherein the method further includes: causing display of, by an interface associated with a user, at least a portion of the tax return model; and indicating the one or more anomalies such that the one or more anomalies are emphasized on the tax structure displayed.

In some aspects, the techniques described herein relate to one or more non-transitory computer-readable media, wherein the tax structure is a directed acyclic graph.

In some aspects, the techniques described herein relate to one or more non-transitory computer-readable media, wherein the tax return model includes a tax return value, the tax return value corresponding to an amount owed or entitled to by the taxpayer.

In some aspects, the techniques described herein relate to one or more non-transitory computer-readable media including computer-executable instructions that, when executed by at least one processor, perform a method of calculating a tax return model associated with a tax year, the method including: generating a tax structure representing the tax year, the tax structure including: one or more nodes including one or more models, the one or more models configured to calculate one or more output values;

and one or more edges, the one or more edges including one or more weights, the one or more weights configured to correspond to the one or more output values, wherein the one or more nodes are connected to at least one node from the one or more nodes by at least one edge from the one or more edges; obtaining tax return information associated with a taxpayer, the tax return information including one or more tax field values; and inputting the one or more tax field values into the tax structure to generate the tax return model such that the one or more models calculate the one or more output values.

In some aspects, the techniques described herein relate to one or more non-transitory computer-readable media, wherein the method further includes: detecting, by an anomaly detector, one or more anomalies in the one or more tax field values.

In some aspects, the techniques described herein relate to one or more non-transitory computer-readable media, wherein the tax return model includes: the one or more nodes outputting the one or more output values; the one or more edges, the one or more edges corresponding to the one or more output values; and one or more indicators attached to at least one node from the one or more nodes and at least one edge from the one or more edges, the one or more indicators configured to indicate the at least one node and the at least one edge corresponding to the one or more anomalies.

In some aspects, the techniques described herein relate to one or more non-transitory computer-readable media, wherein the method further includes: causing display of the one or more indicators attached to the at least one node and the at least one edge.

In some aspects, the techniques described herein relate to one or more non-transitory computer-readable media, wherein the method further includes: causing display of, by a user interface associated with a user, at least one weight from the one or more weights.

In some aspects, the techniques described herein relate to one or more non-transitory computer-readable media, wherein the method further includes: indicating, to a user, one or more documents from the tax return information associated with the one or more anomalies.

In some aspects, the techniques described herein relate to one or more non-transitory computer-readable media, wherein generating the tax structure representing the tax year includes translating, via one or more natural language processing techniques, one or more tax forms.

In some aspects, the techniques described herein relate to a system for modeling a tax return for a tax year, the system including: One or more non-transitory computer-readable media including computer-executable instructions that, when executed by at least one processor, perform a method of modeling a tax return for a tax year, the method including: obtaining, from one or more databases, tax information associated with the tax year, the tax information including tax law; parsing, by a word transformer, one or more tax fields from the tax information; determining, by a relationship transformer, one or more dependencies between the one or more tax fields; generating, using the one or more dependencies and the one or more tax fields, a tax structure including: one or more nodes including one or more models, the one or more models configured to calculate one or more output values; and one or more edges, the one or more edges including one or more weights, the one or more weights corresponding to the one or more output values, wherein the one or more nodes are connected to at least one node from the one or more nodes by at least one edge from the one or more edges; obtaining tax return information associated with the tax return of a taxpayer, the tax return information including one or more tax field values; inputting the one or more tax field values into the tax structure to generate a tax return model such that the one or more models calculate the one or more output values; and causing display of, by a user interface associated with a user, at least a portion of the tax return model.

In some aspects, the techniques described herein relate to a system, wherein the word transformer applies at least one natural language processing technique to the one or more tax fields from the tax information.

In some aspects, the techniques described herein relate to a system, wherein the method further includes: determining one or more anomalies associated with the one or more output values, wherein the at least a portion of the tax return model displayed includes a set of nodes from the one or more nodes and a set of edges from the one or more edges corresponding to the one or more anomalies.

In some aspects, the techniques described herein relate to a system, wherein the one or more nodes being connected to the at least one node by the at least one edge is indicative of the one or more dependencies between the one or more tax fields.

In some aspects, the techniques described herein relate to a system, wherein the method further includes: determining a presence of one or more anomalies in the one or more tax field values; and causing display of, by the user interface associated with the user, one or more indicators associated with the one or more anomalies, the one or more indicators configured to emphasize the one or more nodes associated with the one or more tax field values.

In some aspects, the techniques described herein relate to a system, wherein the one or more models including the one or more nodes are configured to utilize linear regression modeling.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the disclosure will be apparent from the following detailed description of the embodiments and the accompanying drawing figures.

### BRIEF DESCRIPTION OF THE DRAWING FIGURES

Embodiments of the disclosure are described in detail below with reference to the attached drawing figures, wherein:

FIG. 1 depicts an exemplary hardware system in accordance with embodiments of the invention;

FIG. 2 depicts an exemplary system for modeling tax returns in accordance with embodiments of the invention;

FIG. 3 depicts an exemplary graph illustrating a tax structure in accordance with embodiments of the invention;

FIG. 4 depicts an exemplary flowchart for illustrating the operation of a method in accordance with embodiments of the invention;

FIG. 5 depicts an exemplary flowchart for illustrating the operation of a method in accordance with embodiments of the invention; and

FIG. 6 depicts an exemplary graph illustrating a tax return model in accordance with embodiments of the invention.

The drawing figures do not limit the disclosure to the specific embodiments disclosed and described herein. The drawings are not necessarily to scale, emphasis instead being placed upon clearly illustrating the principles of the disclosure.

### DETAILED DESCRIPTION

The following detailed description references the accompanying drawings that illustrate specific embodiments in which the current disclosure can be practiced. The embodiments are intended to describe aspects in sufficient detail to enable those skilled in the art to practice those embodiments of the disclosure. Other embodiments can be utilized, and changes can be made without departing from the scope of the current disclosure. The following detailed description is, therefore, not to be taken in a limiting sense. The scope of the disclosure is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc., described in one embodiment may also be included in other embodiments but is not necessarily included. Thus, the technology can include a variety of combinations and/or integrations of the embodiments described herein.

Generally, embodiments of the present disclosure relate to systems and methods for generating a tax structure and modeling a tax return using the tax structure. In some embodiments, the tax structure may be generated by parsing and translating tax law information using natural language processing techniques. The tax law information may be parsed for tax values associated with the forms, lines, and words of the tax law information as well as dependencies between the tax values. The tax values, as well as the dependencies between them, may then be used to assemble a tax structure. In some embodiments, the tax structure obtains tax return information associated with a taxpayer as well as anomalous value information. The underlying models associated with the nodes of the tax structures may then be calculated with the tax return information. As such, the system may determine how every tax value affects the end result of a tax return. Further, the system may determine how an anomalous value in a tax return affects the end result of the tax return.

### Operational Environment for Embodiments of the Invention

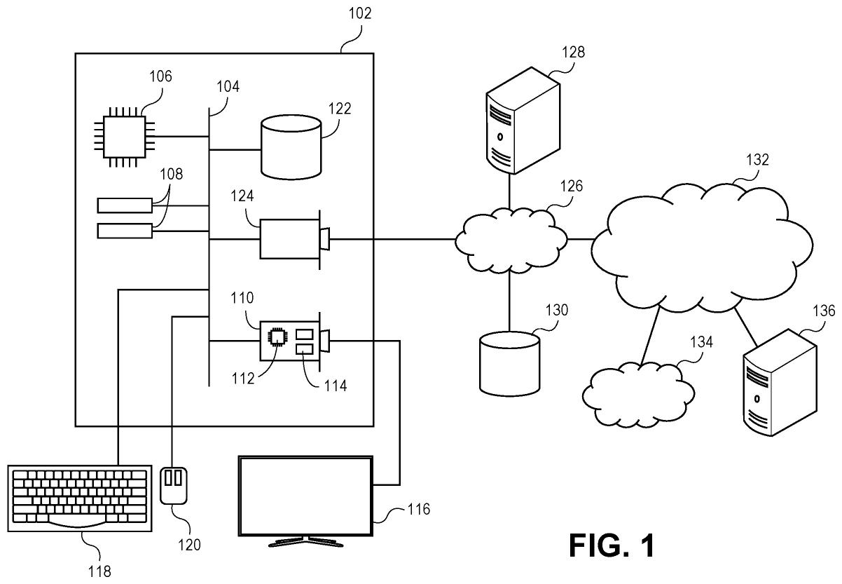

FIG. 1 illustrates one example of a hardware platform representative of an embodiment of hardware system 100 that may comprise modeling system 200 in the embodiments described below. Computer 102 can be any form factor of generalor special-purpose computing device. Depicted with computer 102 are several components for illustrative purposes. In some embodiments, certain components may be arranged differently or absent. Additional components may also be present. Included in computer 102 is system bus 104, whereby other components of computer 102 can communicate with each other. In certain embodiments, there may be multiple buses or components may communicate with each other directly. Connected to system bus 104 is central processing unit (CPU) 106. Also attached to system bus 104 are one or more random-access memory (RAM) modules 108. Also attached to system bus 104 is graphics card 110. In some embodiments, graphics card 110 may not be a physically separate card but rather may be integrated into the motherboard or the CPU 106. In some embodiments, graphics card 110 has a separate graphics processing unit (GPU) 112, which can be used for graphics processing or for general-purpose computing (GPGPU). Also on graphics card 110 is GPU memory 114. Connected (directly or indirectly) to graphics card 110 is display 116 for user interaction. In some embodiments, no display is present, while in others, it is integrated into computer 102. Similarly, peripherals such as keyboard 118 and mouse 120 are connected to system bus 104. Like display 116, these peripherals may be integrated into computer 102 or absent and may be provided as inputs by display 116. Also connected to system bus 104 is local storage 122, which may be any form of computer-readable media and may be internally installed in computer 102 or externally and removably attached.

Computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store non-transitory data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-useable instructions, data structures, program modules, and other data representations. In particular, computer-readable media includes non-transitory computer-readable media storing computer-executable instructions that, when executed, cause one or more processors to carry out operations.

Finally, network interface card (NIC) 124 is also attached to system bus 104 and allows computer 102 to communicate over a network such as local network 126. NIC 124 can be any form of network interface known in the art, such as Ethernet, ATM, fiber, Bluetooth, or Wi-Fi (i.e., the IEEE 802.11 family of standards). NIC 124 connects computer 102 to local network 126, which may also include one or more other computers, such as computer 128, and network storage, such as data store 130. Generally, a data store such as data store 130 may be any repository from which information can be stored and retrieved as needed. Examples of data stores include relational or object-oriented databases, spreadsheets, file systems, flat files, directory services such as LDAP and Active Directory, or email storage systems. A data store may be accessible via a complex API (such as, for example, Structured Query Language), a simple API providing only read, write, and seek operations, or any level of complexity in between. Some data stores may additionally provide management functions for data sets stored therein, such as backup or versioning. Data stores can be local to a single computer, such as computer 128, accessible on a local network, such as local network 126, or remotely accessible over Internet 132. Local network 126 is, in turn, connected to Internet 132, which connects many networks such as local network 126, remote network 134, or directly attached computers such as computer 136. In some embodiments, computer 102 can itself be directly connected to Internet 132.

### System for Modeling Tax Scenarios

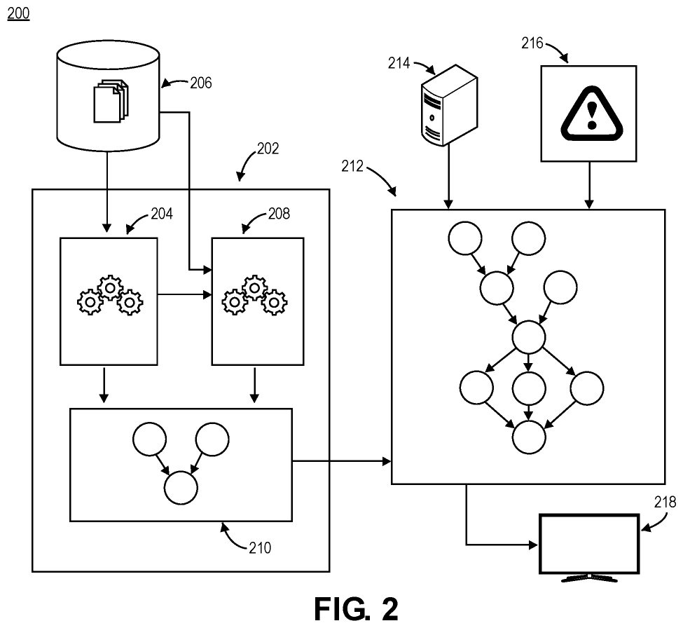

Turning now to FIG. 2, an exemplary modeling system in accordance with embodiments of the invention is depicted and referred to generally by reference numeral 200. In some embodiments, modeling system 200 generates a structure representing a tax year and calculates the result of a given tax return. Through modeling a tax return, the structure may determine how one or more tax decisions and/or errors affect the result of the tax return (e.g., the amount owed/refunded). For example, modeling system 200 may calculate how inputting the incorrect “Wages, tips, other compensation” value on line 1a of the 2022 1040 Form affects the overall amount owed or received by a taxpayer for a for the 2022 tax year. In some embodiments, modeling system 200 may be used to compare multiple tax structures representing different tax years. As such, modeling system 200 may determine how the tax code has differed between multiple years and how that may affect taxpayers' tax returns. In some embodiments, modeling system 200 may proactively determine what a taxpayer's return amount may be for a given year. For example, modeling system 200 may give a user an estimation of their 2023 tax return amount before the user files their taxes.

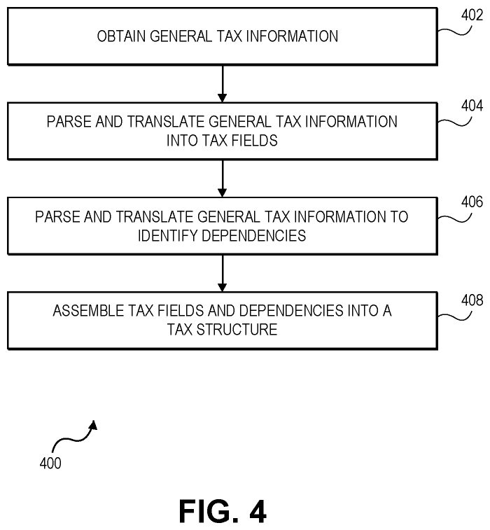

In some embodiments, generator 202 of modeling system 200 constructs a tax structure representing the current tax year. Generator 202 may obtain tax information (e.g., code, regulations, guidance, forms, instructions, manuals, schedules, etc.) for a given year, parse the information, translate the information to computer-readable information, determine the dependencies between the parsed and translated tax fields, and construct a tax structure, such as that illustrated below in FIG. 4. The constructed tax structure may then include all relevant tax fields for a given tax return and the relationships between the tax fields.

In some embodiments, generator 202 includes word transformer 204, relationship transformer 208, and assembler 210. In some embodiments, word transformer 204 obtains tax information from tax data store 206. For example, tax data store 206 may include the Internal Revenue Code, Treasury regulations, Internal Revenue Service guidance documents, and the like. Tax data store 206 may provide word transformer 204 with the collection of forms representing the yearly tax process. For example, tax data store 206 may provide word transformer 204 with all IRS forms that may be necessary for a business or an individual to file taxes, such as the 1040 Form referenced throughout. Further, tax data store 206 may provide word transformer 204 with tax preparation data, such as information relating to previous conversations between tax professionals and taxpayers. Tax data store 206 may also provide word transformer 204 with previously filed tax returns. Accordingly, word transformer 204 may utilize the filed tax returns to determine the meaning of fields in the various tax forms making up the tax structure.

Tax data store 206 may be one or more external databases, such as one or more databases associated with the IRS. Tax data store 206 may also be one or more internal databases, such as one or more company databases storing conversations between tax professionals and customers. Further, tax data store 206 may be a combination of any number of both internal and external databases. Tax data store 206 may be one or more cloud databases. The tax information obtained by word transformer 204 from tax data store 206 may be in any form now known or later developed including text, audio, video, image, and the like. For example, the information obtained may be a collection of PDF tax forms. The tax information obtained by word transformer 204 from tax data store 206 may be in plain text format. The information obtained may also be in formatted text format.

Broadly, word transformer 204 may use machine learning to translate human language into computer-readable language by parsing written documents and determining the meaning of the various sections, lines, sentences, structures, words, and the like. Word transformer 204 may use any natural language processing technique now known or later developed, including, but not limited to, name-entity recognition, relation extraction, text summarization, topic modeling, text classification, keyword extraction, lemmatization and stemming, and similar techniques.

In some embodiments, word transformer 204 may be trained using data sets corresponding to tax scenarios. For example, word transformer 204 may be trained using previous tax conversations held by tax professionals. Word transformer 204 may also be trained using a plurality of tax forms, such as the 1040 Form discussed throughout. The tax forms used to train word transformer 204 may be from the current year and the previous years. Further, word transformer 204 may be trained using tax code, regulations, and guidance, such as the Internal Revenue Code.

In some embodiments, word transformer 204 is a trained name-entity recognition model, where the model is trained to identify, categorize, and extract key information from unstructured text. Word transformer 204 may be any type of name-entity recognition model now known or later developed including, but not limited to, a supervised machine-learning system, an unsupervised machine-learning system, a rule-based system, a dictionary-based system, a bootstrapping system, a neural network system, a statistical system, a semantic role labeling system, a combination of the above-mentioned systems, and the like. To illustrate, word transformer 204 may obtain the raw text of line 9 of form 1040, which states, “Add lines 1z, 2b, 3b, 4b, 5b, 6b, 7, and 8. This is your total income.” word transformer 204 may then parse the raw text to identify “add” as a verb, “lines” and “income” as nouns, “1z”, “2b”, “3b”, etc. as values, and the like. Generally, word transformer 204 will utilize any methods necessary in order to identify and understand the fields making up a given set of tax information.

In some embodiments, word transformer 204 may output a collection of name-value pairs. Word transformer 204 may output values with assigned part-of-speech tags. Continuing the example above, word transformer 204 may construct the following name-value pairs: {add: verb; lines: noun; income: noun; 1z: number; 2b: number; . . . }. The name-value pairs may then be provided to relationship transformer 208 and assembler 210 for further word processing and construction of a tax structure.

In some embodiments, relationship transformer 208 obtains the output of word transformer 204. Relationship transformer 208 may also obtain information from tax data store 206. At a high level, relationship transformer 208 determines the various dependencies and relationships between fields in the computer-readable tax information produced by word transformer 204. For example, relationship transformer 208 may determine that the value of line 1—which states, “Add line 12 and 13”—depends on the values of line 12 and line 13 and the sum of those two values.

In a substantially similar manner to word transformer 204, relationship transformer 208 may utilize machine learning to determine the dependencies between various tax fields. Relationship transformer 208 may use any natural language processing technique now known or later developed for determining the dependencies, including, but not limited to, name-entity recognition, named-entity linking, text summarization, topic modeling, text classification, keyword extraction, lemmatization and stemming, and similar techniques. In some embodiments, similarly to word transformer 204, relationship transformer 208 may be trained using data sets corresponding to tax scenarios, tax conversations held by professionals, current or past tax forms, tax law, tax guidance, tax regulations, and the like.

In some embodiments, as discussed above with regard to word transformer 204, relationship transformer 208 may be a trained name-entity recognition model, where the model is trained to identify, categorize, and extract key information from unstructured text. Word transformer 204 may be any type of name-entity recognition model now known or later developed including, but not limited to, a supervised machine-learning system, an unsupervised machine-learning system, a rule-based system, a dictionary-based system, a bootstrapping system, a neural network system, a statistical system, a semantic role labeling system, a combination of the above-mentioned systems, and the like.

In some embodiments, relationship transformer 208 may use relational models to predict the dependencies between tax fields, including, but not limited to, rule-based relation extraction, weakly supervised relation extraction, supervised relation extraction, distantly supervised relation extraction, unsupervised relation extraction, and similar models. For example, word transformer 208 may use relation extraction to predict the semantic relationships between tax fields in a sentence.

In some embodiments, relationship transformer 208 outputs dependency information. The dependency information may include a variety of dependency types. For example, the dependency information for a line may include the need for a particular checkmark to be marked for a value to be present on said line. For another example, the dependency information may include which forms are necessary for a given tax return when particular lines have nonzero values. For another example, the dependency information may identify which lines are required for a particular arithmetic calculation. For still another example, the dependency information may identify which forms specific values originate from, such as the value of line 8 of the 1040 Form originating from Schedule 1.

In some embodiments, relationship transformer 208 outputs dependency information that identifies which nodes are to be connected to other nodes in a corresponding data structure. For example, as illustrated in FIG. 4, dependency information may identify that node 402b is connected to and depends on node 402a through edge 404a. This may correspond to the fact that node 402b corresponds to line 9 of the 1040 form, where line 9 states, “Add lines 1z, 2b, 3b, 4b, 5b, 6b, 7, and 8. This is your total income” and node 402a corresponds to line 1z of the 1040 form. In some embodiments, relationship transformer 208 may output dependency information in the form of triples, where each triple represents two entities and the relationship between them.

In some embodiments, such as those discussed above, word transformer 204 and relationship transformer 208 are separate engines. In other embodiments, word transformer 204 and relationship transformer 208 are included in a singular engine, such as an engine dedicated to both parsing the meaning of raw text and identifying the relationships between the components identified in the raw text. Word transformer 204 and relationship transformer 208 may perform their functions (described above) contemporaneously, or they may perform their functions in succession.

In some embodiments, assembler 210 obtains the name-value pairs from word transformer 204 and the dependency information from relationship transformer 208. Using the dependency information and the name-value pairs, assembler 210 may construct a tax structure, such as that depicted in FIG. 4 and discussed below. The tax structure may then be used by tax return modeler 212 to model a given tax return.

In some embodiments, assembler 210 may output a tax structure. The tax structure outputted by assembler 210 may be a full representation of a tax year. For example, the tax structure may include all possible fields on all tax forms associated with a given tax year. The tax structure outputted by assembler 210 may represent a single form, such as the 1040 Form. The tax structure outputted by assembler 210 may represent only a particular calculation in a tax year, such as a particular piece of the 1040 Form that is depicted in FIG. 4.

Continuing on, tax return modeler 212 may obtain the assembled tax structure from generator 202. At a high level, tax return modeler 212 may obtain an input of data and calculate the nodes and edges of the tax structure using the input of data. Tax return modeler 212 may then output the final value of a tax return or calculation. This may give a user the ability to see the effect of every calculation taking place in a given tax return.

In some embodiments, tax return modeler 212 obtains tax return information from computer 214. For example, tax return modeler 212 may obtain a collection of documents representing the tax return filing of a taxpayer for a given year. Upon receiving a collection of documents representing the tax return filing of a taxpayer for a given year, tax return modeler 212 may then input the tax return information into the tax structure and create a tax return model, the output of which represents the calculated amount owed.

In some embodiments, tax return modeler 212 obtains a tax structure representing a different tax year than that contained in tax return modeler 212 from computer 214. Tax return modeler 212 may then run a comparison between the tax structure obtained from assembler 210 and the different-year tax structure obtained by computer 214. As such, tax return modeler 212 may determine how the tax code has changed between one or more years.

In some embodiments, computer 214 may be associated with one or more users. The users may be anyone involved in the tax process including, but not limited to, taxpayers, representatives for taxpayers, tax professionals, and the like. Computer 214 may be an automated system that does not require user intervention, wherein the automated system verifies tax returns submitted.

Using the input obtained from computer 214, tax return modeler 212 may model the given tax scenario using the tax structure. At a high level, tax return modeler 212 may input the tax return information obtained into the given tax structure to create a tax return model. By doing so, tax return modeler 212 may be configured to determine how each singular calculation and decision occurring in a tax return affects the final outcome. For example, tax return modeler 212 may illustrate the flow of inputs and outputs through an entire tax calculation.

In some embodiments, tax return modeler 212 obtains anomaly information from anomaly detector 216. Generally, anomaly detector 216 may identify one or more errors (e.g., anomalies) made in the completion of one or more tax forms. In some embodiments, anomaly detector 216 may use machine learning to determine when an error has been made in the completion of a tax form. Anomaly detector 216 may be any system now known or later developed for identifying errors in completed tax fields including, but not limited to, a system that utilizes machine learning to identify errors. For example, anomaly detector 216 may include a series of models trained to identify and flag errors and other anomalies. Accordingly, anomaly detector 216 may be trained using any suitable material for determining non-anomalous values for given tax fields, including past returns, advice given by tax professionals, tax guidance, and the like. For example, anomaly detector 216 may be trained on a set of data of known tax values such that any value differing from the known tax values is likely anomalous.

By way of example, the 2022 standard deduction amounts may be included in the training data set used to train anomaly detector 216. Due to the static nature of the standard deduction amounts, anomaly detector 216 may flag any standard deduction field value that differs from the standard deduction amounts known by anomaly detector 216. For example, if a tax return elects single status but has a value of $25,900 inputted for the standard deduction, anomaly detector 216 may mark the standard deduction amount as anomalous since it differs from the 2022 single-status standard deduction amount of $12,950. It is contemplated that a number of systems may be included in anomaly detector 216 including U.S. patent application, filed Aug. 4, 2021, which is hereby incorporated by reference in its entirety as if set forth herein verbatim: U.S. application Ser. No. 17/394,199, titled “AUTOMATED RETURN EVALUATION WITH ANOMALY DETECTION.” The subject matter described in the foregoing U.S. patent application may be combined with the subject matter of the present disclosure. For example, one or more embodiments, features, structures, acts, etc. described in the foregoing U.S. patent application may be combined with one or more embodiments, features, structures, acts, etc. described in the present disclosure.

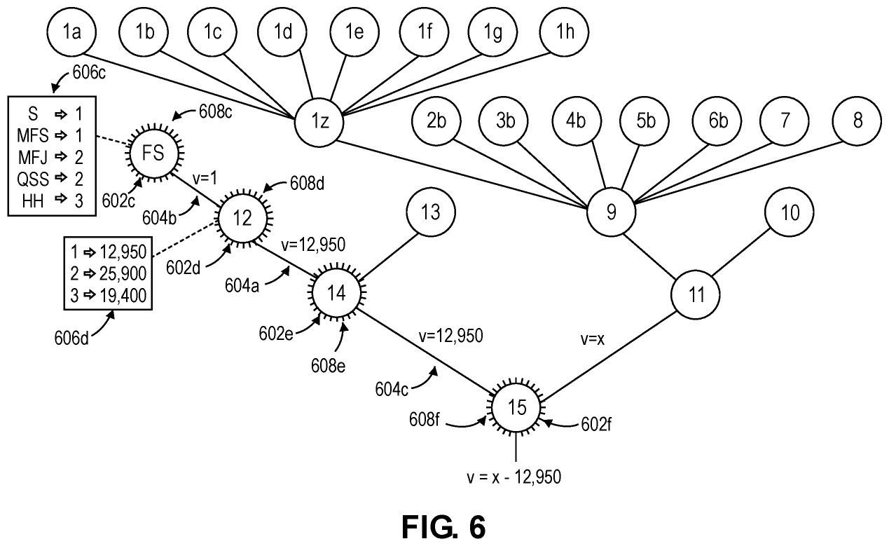

In some embodiments, tax return modeler 212 outputs a calculated tax structure to be displayed to a user via interface 218. For example, a user may see the entire tax structure as a graph (as depicted in FIG. 4). Thus, a user may see how each value on each line of a tax return affects the outputs from nodes that influence subsequent nodes. Additionally, as discussed below with regard to FIG. 6, the calculated tax structure may be displayed to a user via interface 218 such that any detected anomalies are highlighted. By doing so, a user may be able to see how a particular error affected the ending calculation visually. As such, a user may easily see how singular changes may affect the amount they owe or are owed by the taxing body.

### Generating Tax Structures

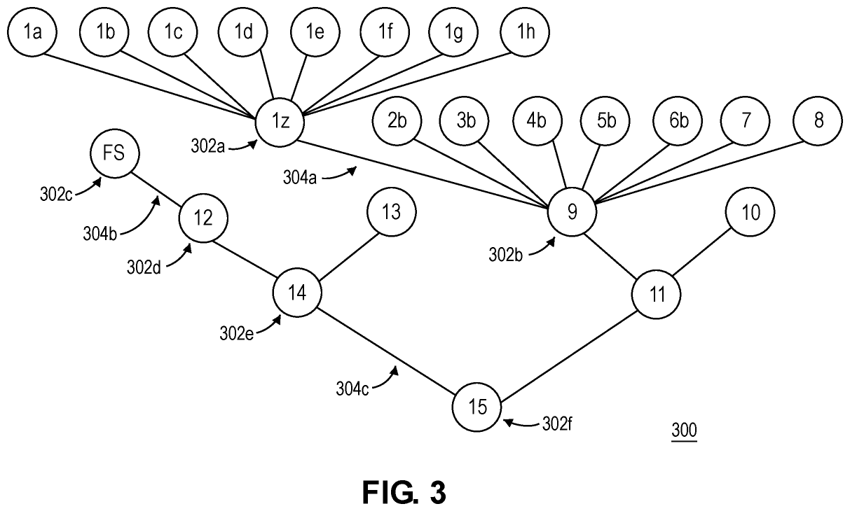

FIG. 3 depicts an exemplary tax structure 300 in accordance with some embodiments of the present disclosure. Broadly, tax structure 300 may include a plurality of nodes 302 and a plurality of edges 304 organized to reflect the logical structure of a tax return. Accordingly, tax structure 300 may be any data structure now known or later developed capable of storing data and the dependencies between data points including, but not limited to, tree structures and graphs. For example, tax structure 300 may be a directed acyclic graph (i.e., a directed graph with no cycles) such as that depicted in FIG. 3. As such, tax structure 300 may include nodes connected by weighted, directed edges such that there are no cycles in the graph. In some embodiments, tax structure 300 is a computational graph. For example, tax structure 300 may be a directed graph where the nodes contain functions, the outputs of which become inputs for subsequent nodes containing functions. It may be noted herein that tax structure 300 may be generated by any processes and/or systems now known or later developed including, but not limited to, method 400 and generator 202 discussed above.

In some embodiments, each node in the plurality of nodes 302 represents the underlying calculation of a tax line and/or tax field on a tax form. For example, node 302a may represent line 1z of the 1040 Tax Form, including the underlying calculation of line 1z. Further, the plurality of nodes 302 may be connected to any other number of nodes by a corresponding number of edges from the plurality of edges 304, the plurality of edges 304 representing the relationships and/or dependencies between nodes in the plurality of nodes 302. For example, there are eight edges entering node 302a, given the fact that the calculation of line 1z includes the addition of eight values. An edge from the plurality of edges 304 may include a weight (e.g., a numerical value associated with an edge) representing the output value of one node and the input value for another node. For example, edge 304c exiting node 302e (which represents line 14 of the 1040 Form) may have a weight equal to the sum of the values of line 12 and line 13. Accordingly, the value of edge 304c may then flow to node 302f (representing line 15 of the 1040 Form). In some embodiments, the plurality of edges 304 may be directed; that is, the weight (e.g., value) attached to an edge from the plurality of edges 304 may be obtained from a first node and flow to a second node such that the weight cannot flow from the second node to the first node. Other embodiments are contemplated, without departing from the scope of the invention, where nodes are representative of both values and functions, edges are representative only of the direction of flow of information, edges are representative of computations and/or models, and the like.

In some embodiments, the plurality of nodes 302 includes an underlying model for running one or more tax return calculations. Accordingly, the plurality of nodes 302 may obtain one or more inputs, run a calculation, and output one or more results. For example, node 302e may contain the value of line 14 of the 1040 Form, which recites “Add lines 12 and 13.” Thus, node 302e obtains the values of lines 12 and 13, adds the values together, and outputs the sum. The output of node 302e is then obtained by node 302f, which corresponds to line 15 of the 1040 form, which asks a user to “Subtract line 14 from line 11 . . . . This is your taxable income.” The underlying models of the plurality of nodes 302 may utilize any number and type of algorithm now known or later developed, including, but not limited to, the delta function, linear regression analysis, and the like.

In some embodiments, a node in the plurality of nodes 302 may output a numerical value. For example, a node may output the value of total wages. For another example, node 302a may correspond to line 1z on the 2022 1040 Form such that node 302a outputs the sum of the values of lines 1a-1h. The plurality of nodes 302 may further include boundaries for numerical values such that the output does not go beyond a predetermined threshold. For example, node 302f represents line 15 of the 1040 Form, which states, “Subtract line 14 from line 11. If zero or less, enter -0-. This is your taxable income.” In this case, the model underlying node 302f may restrict the calculated value to a lower boundary of 0 such that the value outputted from node 302f cannot be less than zero. Thus, if the output of node 302e (which represents line 14) is a greater value than the value of line 11, Node 15 (which subtracts line 14 from line 11) would output 0 rather than a negative number.

In some embodiments, the plurality of nodes 302 may include discrete values or checkboxes such that the nodes output weights corresponding to those discrete values. For example, as illustrated in FIG. 3, node 302c may represent the filing status of a taxpayer, the determination of which affects the weight of edge 304b. For another example, node 302c may represent a check box value, such as whether a filer checked single, married filing jointly, married filing separately, head of household, or qualifying surviving spouse for filing status. When the filer checks a particular status, a corresponding weight may be given to edge 304b so node 302d may retrieve the proper standard deduction amount for a given filing status. Accordingly, node 302c may output 1 for Single filing status and output 2 for Married Filing Jointly filing status. For another example, a node may output 1 if a checkbox is checked or output 0 if the checkbox is unchecked.

Turning now to FIG. 4, an exemplary method of constructing a structure representing a given tax year is depicted and generally referenced by the numeral 400. Method 400 may be carried out in whole or in part by any system or systems, including generator 202 described above. Method 400 may produce a tax structure such as tax structure 300 depicted in FIG. 4.

At step 402, general tax information is obtained. At a high-level, the general tax information obtained may be utilized to determine the set of tax values that make up a tax return and how those values inform other tax values in the set. The general tax information may include any information involving the tax process now known or later developed including, but not limited to, tax code, tax laws, tax regulations, tax guidance, tax forms, and the like. For example, the general tax information may include all forms and guidance necessary for an individual taxpayer to complete their yearly tax return, such as the 1040 Form, accompanying instructions for the 1040 Form, and Schedule A for the 1040 Form. Further, the general tax information obtained may cover all possible tax elections and scenarios, such as if a taxpayer owns a business and is required to fill out a Schedule C for the 1040 Form.

The general tax information may be obtained in any text format now known or later developed, such as plain text or formatted text. In some embodiments, as illustrated in FIG. 2, the general tax information may be from external tax data stores, internal data stores, cloud-based data stores, or any combination thereof. For example, the general tax information may be obtained in PDF format from the Internal Revenue Service website.

At step 404, The general tax information is parsed and translated into computer-readable tax fields. At a high level, any number of components of the general tax information may be parsed and translated into computer-readable tax fields including, but not limited to, forms, lines, sentences, words, and any other whole or partial components of general tax information. By parsing and translating into tax fields, the system may identify one or more values present in the general tax information and may then construct a tax structure accordingly.

In some embodiments, as discussed above with respect to word transformer 204, the general tax information is parsed using machine learning, including natural language processing. Any technique of natural language processing now known or later developed may be utilized, including, but not limited to, name-entity recognition, text summarization, topic modeling, text classification, keyword extraction, lemmatization and stemming, and similar techniques. In some embodiments, as discussed above, the general tax information may be parsed into name-value pairs corresponding to the tax fields.

By way of example, assume the general tax information received includes line 11 of the 2022 1040 Form which reads, “Subtract line 10 from line 9. This is your adjusted gross income.” Using a named-entity recognition model trained on tax-related data sets, a system may match the words making up line 11 to known entities and/or categories. For example, a system performing method 400 may match words to grammatical types, thus identifying the word “subtract” as a verb, “line” as a noun, “10” and “9” as numbers, and “from” as a preposition. For another example, a system performing method 400 may match words to tax form parts, thus identifying “line 10” and “line 9” and corresponding to the “Line” category of tax form parts. Accordingly, the word transformer may translate underlying instructions and/or meanings communicated in human-readable language to machine-understandable instructions and/or meanings. For example, the word transformer may be able to translate the verb “subtract” to be understood by a machine as requesting an arithmetic calculation.

At step 406, the general tax information is parsed and translated to identify relationships and dependencies. In some embodiments, as discussed above with respect to relationship transformer 208, the general tax information from the tax data source and the name-value pairs from the word transformer 204 are utilized to identify and categorize dependencies among the extracted values. In other embodiments, only one of the general tax information or the output from the word transformer 204 is necessary to identify relationships and dependencies. The relationships and dependencies identified may include arithmetic operations occurring that require the values of multiple lines. In some embodiments, the relationships and dependencies identified include which nodes are to be connected to other nodes by one or more edges in a corresponding data structure.

To illustrate, assume the relationship transformer receives line 11 of the 2022 1040 Form which reads, “Subtract line 10 from line 9. This is your adjusted gross income.” The relationship transformer may receive line 11 in the form presented above, or the relationship transformer may receive line 11 in name-value pairs, such as pairs that identify subtract” as a verb, “line” as a noun, “10” and “9” as numbers, and “from” as a preposition. The relationship transformer may then parse line 11 to translate relationships communicated in human-readable language to machine-understandable dependencies. For example, the relationship transformer may identify the verb “subtract” as signaling a dependency on two or more values to complete the arithmetic calculation associated with the verb “subtract.” In this case, the relationship transformer may identify the verb “subtract” as relying on the values associated with the Lines “line 9” and “line 10” in the Line category. As such, relationship transformer may identify the need to receive inputs from both the node representing line 9 and the node representing line 10 in order to complete the underlying function of the node associated with line 11 and output the result of said function, which may then serve as an input for a subsequent line dependent on the value of line 11.

At step 408, the computer-readable tax fields and the identified dependencies and relationships are assembled into a tax structure. The tax structure may directly correspond to any tax calculation or group of calculations now known or later developed including, but not limited to, a portion of a tax form, a complete tax form, a collection of tax forms, an entire tax return, and the like. Broadly, the tax structure may be meant to capture the value of identified tax fields, as well as the existing dependencies between the identified tax fields. Accordingly, as discussed below with regard to method 500, the tax structure may then be used to model a given tax return.

Broadly, the tax structure may be assembled by inputting the tax fields and the identified dependencies into a data structure such that the data structure reflects the relationships between the values of the tax fields. Doing so may involve matching a tax field to the dependencies identified by the relationship transformer as being associated with that tax field. For example, line 11 of the 2022 1040 Form reads, “subtract line 10 from line 9. This is your adjusted gross income.” Therefore, the tax field associated with line 11 may be inputted into a data structure such that there is a logical connection drawn between the value of line 11 and the values of line 9 and line 10, given that the value of line 11 relies on line 9 and 10 for inputs. Further, line 15 of the 2022 1040 reads, “subtract line 14 from line 11.” As such, the tax fields associated with line 11 and line 14 may be inputted into a data structure such that there is a logical connection drawn between lines 11 and 14 and line 15, since the value of lines 11 and 14 are inputs for line 15.

Continuing forth the example, line 11 and its various relationships may be assembled into a computational graph. For example, a node may represent the underlying calculation of line 11 (e.g., the subtraction of line 10 from line 9). As such, the node associated with line 11 may be connected with the nodes associated with line 9 and line 10 through a plurality of directed edges, where the edges' values flow from the nodes associated with lines 9 and 10 to the node associated with line 11. Further, the output of the node associated with line 11 may be the resulting value after the calculation has been performed. Accordingly, the output of the node associated with line 11 may flow to the node associated with line 15 through a directed edge connecting line 11 to line 15. The resulting structure is a computational graph with four nodes representing lines 9-11 and 15 and three edges connecting lines 9, 10, and 15 to node 11.

### Modeling Tax Returns

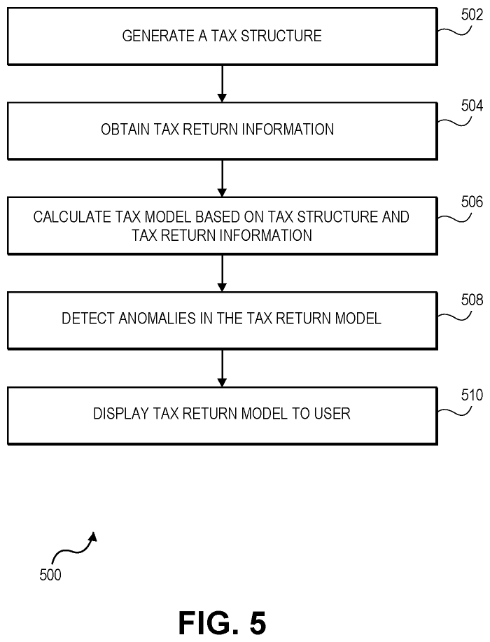

Turning now to FIG. 5, an exemplary method of calculating the effects of one or more tax inputs on the return result is depicted and generally referred to by reference numeral 500. Method 500 may be carried out in whole or in part by any system or systems, including tax return modeler 212 described above.

At step 502, a tax structure representing a given tax year is generated. The tax structure may be generated by any process now known or later developed for generating data structures, including, but not limited to, method 400 described above. As discussed above with respect to tax structure 300, the tax structure may be any data structure now known or later developed capable of storing data points and the dependencies between the data points, including, but not limited to, tree structures and graphs. In some embodiments, the tax structure may be a directed acyclic graph like that depicted in FIG. 4.

Generally, as discussed above with regard to FIG. 4, the tax structure may be formed from a plurality of organized nodes and edges connecting the nodes. In some embodiments, each node represents one or more fields on a tax form. More specifically, each node may include an underlying model that performs a calculation associated with the corresponding line/tax field. Each node may then be connected to other nodes by directed edges, the directed edges representing the dependencies between nodes in the plurality of nodes. For example, a directed edge from a first edge to a second edge may indicate that the value of the first node is used to calculate the value of the second node. In some embodiments, the plurality of edges may include weights (e.g., values) representing the output and input value for various nodes.

At step 504, tax return information from a user is obtained by the modeler. The tax return information may include any information associated with tax returns. For example, the tax return information may include the entirety of a taxpayer's tax return documents. In some embodiments, the tax return information may be obtained from a computer associated with a user. The user may be any person and/or entity involved in the tax process including, but not limited to, a taxpayer, a representative of a taxpayer, a tax professional, and the like. In other embodiments, the tax return information may be obtained from an automated system. For example, the tax return information may be obtained from a system that automatically verifies the accuracy of tax returns upon submittal to the system.

At step 506, a tax return model is calculated by the modeler based on the tax return information and the tax structure. The tax return model may be calculated by any suitable system and/or process now known or later developing including, but not limited to, tax return modeler 212 as part of system 200. At a high level, the modeler may input the tax information from the user into the tax structure such that the various models housed by the nodes of the tax structure are calculated. Upon the tax return model being calculated, each node may have a particular output that becomes the input for one or more additional nodes, with the final node returning the result of a given tax return, such as the amount owed by an individual taxpayer to the IRS. Upon being calculated, each node may have an output value that correlates to the weight of one or more edges. For example, as depicted in FIG. 6, node 402e corresponds to line 14 such that the model at node 402e calculates the sum of line 12 and line 13. Accordingly, if line 12 has the value of 12,950 and line 13 has the value of 0, then the output of node 402e will be 12,950. This value will then become input for node 402f, which corresponds to line 15.

At step 508, anomalies in the tax return model are detected. Anomalies may be detected using any suitable systems or methods now known or later developed including, but not limited to, anomaly detector 216 as part of system 200. In some embodiments, anomalies may be detected in the tax return information, rather than in the tax return model. For example, before inputting the tax return information into the tax structure, the system may detect the presence of one or more anomalies in the tax return information.

Any type of anomaly may be detected in tax return model, including, but not limited to, less advantageous tax selections, human error, and changes from one tax year to the next. In some embodiments, an anomaly may only be identified at the first node in which the error occurred. In other embodiments, an anomaly may be identified at every node in which the anomalous value affects the output, including all subsequent nodes in which the output from a node with an anomalous value flows.

In some embodiments, when an anomalous value is detected, tax return model may identify the one or more documents and/or one or more document components from the obtained tax information that the anomalous value originates from. For example, if a taxpayer mistakenly writes down the wrong standard deduction value for their elected filing status, the tax return model may direct the user to line 12 of the 1040 Form. Accordingly, the taxpayer may be able to more efficiently locate and correct any anomalies detected.

At step 510, the tax return model is displayed to the user. The tax return model may be displayed by any suitable process or system now known or later developed, including, but not limited to, interface 218 in modeling system 200. In some embodiments, the tax return model may be displayed as a data structure. For example, the tax return model may appear as a graph of nodes and directional edges (such as tax return model 600 described below). Accordingly, the user would be presented with a structure in which they may visualize the flow of calculations of their tax return to an end result.

In some embodiments, the entirety of the tax structure may be visible to a user. As such, the user may see the entirety of the structure representing a taxpayer's tax return. Conversely, only portions of the tax structure may be visible to a user. By only showing a portion of the tax structure to a user, the user's attention may be directed to a particular aspect of a taxpayer's tax return, such as a portion that contains one or more errors. In some embodiments, as discussed below with regard to tax return model 600, the tax return model may include one or more indicators attached to one or more nodes and/or edges. The one or more indicators may be used to emphasize a detected anomaly such that a user can locate it and/or see its effects on other values. The one or more indicators may also show how a deviation affects every dependent calculation so as to change the final return value. For example, the displayed tax return model may show how a certain tax delegation affects the return received by a taxpayer.

FIG. 6 depicts an exemplary tax return model as displayed to a user. Generally, the underlying tax structure of tax return model 600 may be substantially similar to tax structure 300 depicted in FIG. 3. As discussed above with regard to FIG. 3, the tax structure underlying tax return model 600 may include a plurality of nodes 602 and a plurality of edges 604 connecting the plurality of nodes 602. In some embodiments, each node represents one or more fields on a tax form. Each node may be connected to other nodes by edges, the edges representing the dependencies between nodes in the plurality of nodes. In some embodiments, each edge of the plurality of edges may include a weight (e.g., value) corresponding to the output of one node and input of another.

In some embodiments, tax return model 600 may be displayed to a user via an interface, such as interface 218 depicted in FIG. 2. The interface may include any interface now known or later developed, including, but not limited to, a personal computer, an interface at a tax preparation business, a mobile device, and the like. The user may be any person involved in the tax process including, but not limited to, a taxpayer, a representative of a taxpayer, a tax professional, and the like.

At a high level, by presenting a user with a visual depiction of a tax model representing a tax return, the user may visualize how each tax decision affects the overall resulting amount. The user may be presented with a portion of the tax return model 600, or the entirety of the tax return model 600. For example, a user may only be shown the portion of tax return model 600 corresponding to detected anomalies in a given tax return so that they may more efficiently locate and correct the tax return anomalies.

In some embodiments, tax return model 600 includes a plurality of calculated nodes 602. In some embodiments, the underlying calculation of the plurality of calculated nodes 602 is displayed to the user. For example, underlying calculation 606c may be displayed for node 602c, where underlying calculation 606c assigns a value to the filing status selected by a taxpayer. As such, if the taxpayer selects “single” as their filing status, underlying calculation 606c may assign the value of 1 to the output of node 602c, which then becomes the value of edge 604b. Further, the value of edge 604b may then be the input of node 602d. As such, underlying calculation 606d may correspond the input of 1 to the value 12,950, which then becomes the output of node 602d. Accordingly, the user may understand how a particular output was reached for a node. The underlying calculations of every node may be displayed, or only a portion of the underlying calculations may be displayed. For example, only the underlying calculations for nodes in which anomalous values are associated may be displayed, as for node 602c and node 602d in FIG. 6.

In some embodiments, the outputs of the plurality of nodes 602 correspond to the values of the plurality of calculated edges 604. For example, the value of edge 604a may correspond to the output of node 602e (representing line 14 of the 1040 Form). As such, the value of edge 604c may equal the sum of lines 12 (node 402d) and line 13 (which, as depicted, has a value of 0). In some embodiments, the weights of the plurality of calculated edges 604 may be displayed to the user. All of the weights of the plurality of calculated edges 604 may be displayed to the user, or a subset of the weights may be displayed to the user. For example, as depicted in FIG. 6, only the weights of the plurality of edges 604 associated with anomalous values are displayed—that is, the weights of edge 604a, edge 604b, and edge 604c are displayed to a user.

In some embodiments, tax return model 600 includes one or more indicators 608 attached to the plurality of calculated nodes 602 or plurality of calculated edges 604.

The one or more indicators 608 may be any form of indication now known or later developed including, but not limited to, highlighting, italicizing, bolding, coloring, and the like. The one or more indicators 608 may be used to emphasize one or more nodes from the plurality of calculated nodes 602 and/or one or more edges from the plurality of calculated edges 604. In some embodiments, tax return model 600 may indicate one or more documents to the user. Tax return model 600 may indicate to a user when one or more documents needs to be filled out to complete the tax return. Further, tax return model 600 may indicate to a user one or more documents that need to be corrected.

In some embodiments, the nodes and/or edges with one or more anomalies identified in tax return model 600 are marked with the one or more indicators 608. As discussed above, the one or more anomalies may be detected using any suitable method and/or system now known or later developed including anomaly detector 216 from modeling system 200. In some embodiments, only the node in which the anomaly originated may include one or more indicators 608. In other embodiments, all nodes and/or edges with values that have been affected by an anomaly may include one or more indicators 608. In still other embodiments, a portion of the nodes and/or edges affected by an anomaly may include one or more indicators 608.

To illustrate, node 402c represents a taxpayer's filing status. If a taxpayer mistakenly elects married filing separately instead of married filing jointly, node 402d (which identifies a standard deduction amount based on the filing status) may output a standard deduction amount of 12,950 instead of 25,900. Thus, node 402e (which adds line 12 and 13) will calculate a value much less than if the proper filing status had been elected. As such, node 402f (line 15) may calculate a total taxable income that is much higher than if the proper status was elected. As such, node 602c may include indicator 608c, node 602d may include indicator 608d, node 602e may include indicator 608e, and node 602f may include indicator 608f, due to the error in filing status that originated in node 402c.

Although current disclosure has been described with reference to the embodiments illustrated in the attached drawing figures, it is noted that equivalents may be employed, and substitutions made herein without departing from the scope of the disclosure as recited in the claims.

Having thus described various embodiments, what is claimed as new and desired to be protected by Letters Patent includes the following:

1. One or more non-transitory computer-readable media comprising computer-executable instructions that, when executed by at least one processor, perform a method of generating a tax structure modeling a tax year, the method comprising:
obtaining tax information associated with the tax year, the tax information comprising tax instructions;
parsing a plurality of tax fields from the tax information;
determining a plurality of dependencies between the plurality of tax fields; and
generating, using the plurality of dependencies and the plurality of tax fields, the tax structure comprising:
a plurality of nodes including a plurality of models, the plurality of models configured to calculate a plurality of output values; and
a plurality of edges, the plurality of edges including a plurality of weights, the plurality of weights corresponding to the plurality of output values,
wherein the plurality of nodes are connected to at least one node from the plurality of nodes by at least one edge from the plurality of edges.

2. The one or more non-transitory computer-readable media of claim 1,
wherein the tax structure is a first tax structure, and the tax year is a first tax year,
wherein the method further comprises:
receiving a second tax structure modeling a second tax year, the second tax year being different than the tax year; and
comparing the second tax structure to the tax structure such that a set of differences between the tax year and the second tax year may be determined.

3. The one or more non-transitory computer-readable media of claim 1, wherein the method further comprises:
obtaining tax return information associated with a taxpayer, the tax return information including a plurality of tax field values; and
inputting the plurality of tax field values into the tax structure to create a tax return model such that the plurality of models calculate the plurality of output values.

4. The one or more non-transitory computer-readable media of claim 3, wherein the method further comprises:
detecting, by an anomaly detector, an anomaly associated with the plurality of output values.

5. The one or more non-transitory computer-readable media of claim 4, wherein the method further comprises:
causing display of, by an interface associated with a user, at least a portion of the tax return model; and
indicating the anomaly such that the anomaly is emphasized on the tax structure displayed.

6. The one or more non-transitory computer-readable media of claim 1, wherein the tax structure is a directed acyclic graph.

7. The one or more non-transitory computer-readable media of claim 3, wherein the tax return model comprises a tax return value, the tax return value corresponding to an amount owed or entitled to by the taxpayer.

8. A method for calculating a tax return model associated with a tax year, the method comprising:
generating a tax structure representing the tax year, the tax structure comprising:
a plurality of nodes including a plurality of models, the plurality of models configured to calculate a plurality of output values; and
a plurality of edges, the plurality of edges including a plurality of weights, the plurality of weights configured to correspond to the plurality of output values,
wherein the plurality of nodes are connected to at least one node from the plurality of nodes by at least one edge from the plurality of edges;
obtaining tax return information associated with a taxpayer, the tax return information including a plurality of tax field values; and
inputting the plurality of tax field values into the tax structure to generate the tax return model such that the plurality of models calculate the plurality of output values.

9. The method of claim 8, the method further comprising:
detecting, by an anomaly detector, an anomaly in the plurality of tax field values.

10. The method of claim 9, wherein the tax return model further comprises:
the plurality of nodes outputting the plurality of output values;
the plurality of edges, the plurality of edges corresponding to the plurality of output values; and
a plurality of indicators attached to at least one anomalous node from the plurality of nodes and at least one anomalous edge from the plurality of edges, the plurality of indicators configured to indicate the at least one anomalous node and the at least one anomalous edge corresponding to the anomaly.

11. The method of claim 10, the method further comprising:
causing display of the plurality of indicators attached to the at least one anomalous node and the at least one anomalous edge.

12. The method of claim 8, the method further comprising:
causing display of, by a user interface associated with a user, at least one weight from the plurality of weights.

13. The method of claim 9, the method further comprising:
indicating, to a user, a document from the tax return information associated with the anomaly.

14. The method of claim 8, wherein generating the tax structure representing the tax year comprises translating, via one or more natural language processing techniques, a plurality of tax forms.

15. A system for modeling a tax return for a tax year, the system comprising:
a word transformer operable to obtain tax information and parse a plurality of tax fields from the tax information;
a relationship transformer operable to obtain the plurality of tax fields and determine a plurality of dependencies between the plurality of tax fields; and
one or more non-transitory computer-readable media comprising computer-executable instructions that, when executed by at least one processor, perform a method of modeling the tax return for the tax year, the method comprising:
obtaining, from a data store, the tax information associated with the tax year, the tax information comprising tax instructions;
parsing, by the word transformer, the plurality of tax fields from the tax information;
determining, by the relationship transformer, the plurality of dependencies between the plurality of tax fields;
generating, using the plurality of dependencies and the plurality of tax fields, a tax structure comprising:
a plurality of nodes including a plurality of models, the plurality of models configured to calculate a plurality of output values; and
a plurality of edges, the plurality of edges including a plurality of weights, the plurality of weights corresponding to the plurality of output values,
wherein the plurality of nodes are connected to at least one node from the plurality of nodes by at least one edge from the plurality of edges;
obtaining tax return information associated with the tax return of a taxpayer, the tax return information including a plurality of tax field values;
inputting the plurality of tax field values into the tax structure to generate a tax return model such that the plurality of models calculate the plurality of output values; and
causing display of, by a user interface associated with a user, a portion of the tax return model.

16. The system of claim 15, wherein the word transformer applies at least one natural language processing technique to the plurality of tax fields from the tax information.

17. The system of claim 15, wherein the method further comprises:
identifying an anomaly associated with the plurality of output values, wherein the portion of the tax return model displayed includes a set of nodes from the plurality of nodes and a set of edges from the plurality of edges corresponding to the anomaly.

18. The system of claim 15, wherein the plurality of nodes being connected to the at least one node by the at least one edge is indicative of at least one dependency from the plurality of dependencies between the plurality of tax fields.

19. The system of claim 15, wherein the method further comprises:
determining a presence of an anomaly in the plurality of tax field values; and
causing display of, by the user interface associated with the user, an indicator associated with the anomaly, the indicator configured to emphasize an anomalous node from the plurality of nodes associated with the plurality of tax field values.

20. The system of claim 15, wherein the plurality of models comprising the plurality of nodes are configured to utilize linear regression modeling.
